(19) United States
(12) Patent Application Publication
(10) Pub. No.: US 2007/0078961 A1
(43) Pub. Date: Apr. 5, 2007

(54) Method for distributing data input/output load

(76) Inventors: Seiichi Kumano, Yokohama (JP); Yoshifumi Takamoto, Kokubunji (JP); Takao Nakajima, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/283,881

(22) Filed: Nov. 22, 2005

(30) Foreign Application Priority Data
Sep. 14, 2005 (JP) 2005-266278

(51) Int. Cl. G06F 15/173

(52) U.S. Cl. 709/223

(57) ABSTRACT

A method for distributing data input/output load is performed by a management server which is connected to at least one storage device for storing data and for inputting or outputting the stored data in response to an external request, one or more computers for performing predetermined processes and making a request for input and output of the data stored in the storage device if necessary, and more than one switches each of which has a port connected to the storage device and the computers and provides a connection between each port of the switches.

### CROSS-REFERENCE TO RELATED APPLICATIONS

This application claims the benefit of Japanese Patent Application 2005-266278 filed on Sep. 14, 2005, the disclosure of which is incorporated herein by reference.

### BACKGROUND OF THE INVENTION

1. Field of the Invention

The present invention relates to a technology for distributing loads of data input/output when a computer inputs or outputs the data to a storage device.

2. Description of the Related Art

Assumed that there are plural servers (computers) and a blade server in which fibre channel switches (hereinafter referred to as “FC switches”) are incorporated. In the blade server, each server is connected to its corresponding FC switch, which is further connected to a channel of an external storage device. Each server executes a data I/O operation to the external storage device through the FC switch in order to accumulate data handled by application programs or the like and to inquire the accumulated data. The storage device comprises plural channels used for a data I/O operation when receiving a data I/O request from any of the servers. A system that comprises at least one blade server and a storage device is referred to as “a blade server”. As a related art of this system, a technology in SAN (Storage Area Network) system is disclosed in JP-A-2002-288105 in which line capacity of how much a user server can transmit data for a certain time period is limited, whereby a preferable response performance is maintained over the entire system.

However, in this conventional art, there is a disadvantage that the transfer rate of data flowing into/from a same channel via the FC switch significantly increases if plural servers exist in a same blade server, each of which has a program applying a high load of data input/output (hereinafter referred to as “I/O load”) on the storage device while performing its task, and this causes an access concentration to the same channel of the storage, resulting in the deterioration of (I/O) performance of the storage.

### SUMMARY OF THE INVENTION

To solve the above mentioned disadvantages, the present invention provides a method for distributing I/O load between servers in a server system.

According to the method for distributing I/O load between the servers in the server system of the present invention, there is provided a method for distributing data input/output load performed by a management server connected to:

at least one storage device for storing data and for inputting or outputting the stored data in response to an external request;

one or more computers for performing predetermined processes and making a request for input and output of the data stored in the storage device if necessary; and

more than one switches, each of the switches having a port connected to the storage device and the computers, and providing a connection between each port of the switches.

The method comprises:

storing input and output management information on data input/output status of each port, and port connection management information for managing the computers and the storage device connected to each port on an appropriate memory of the management server;

inputting the data input/output status of each port from the corresponding switch thereof at predetermined time intervals, so as to reflect the status on the input and output management information;

inquiring the input and output management information and the port connection management information at predetermined time intervals, so as to determine ports having a great load and ports having a small load among ports connected to a same storage device of the storage devices;

checking whether or not a difference or a ratio of load between the ports having the great load and the ports having the small load is within an allowable range;

if the difference or the rate is beyond the allowable range, inquiring the input and output management information, so as to select a port having the great load out of the ports connected to the computers of a first switch with which the determined ports having the great load are equipped, and inquiring the input and output management information, so as to select a port having the small load out of the ports connected to the computers of a second switch with which the determined ports having the small load are equipped; and

inquiring the port connection management information, exchanging a disk image of a computer connected to the selected port having the great load and a disk image of a computer connected to the selected port having the small load.

### BRIEF DESCRIPTION OF THE DRAWINGS

FIG. 1 shows a configuration of a server system according to an embodiment of the present invention.

FIG. 2 shows a configuration of a server unit and its peripheral.

FIG. 3 show a configuration of an FC switch monitoring system for a FC switch and its peripheral.

FIG. 4 shows a program configuration of a management server.

FIG. 5 shows a program configuration of a security system of a disk array device.

FIG. 6 shows an outline of an access from a server to the disk array device.

FIG. 7 shows a configuration of a server management table of the management server.

FIG. 8 shows a configuration of a FC connection information management table of the management server.

FIG. 9 shows a configuration of a FC performance information management table of the management server.

FIG. 10 shows an outline of a reconfiguration process (migration) between servers.

FIG. 11 shows an outline of a reconfiguration process (result of migration) between the servers.

FIG. 12 shows an outline of a reconfiguration process (exchanging) between the servers.

FIG. 13 shows an outline of a reconfiguration process (result of exchanging) between the servers.

FIG. 14 is a flow chart for explaining a process of a FC performance monitoring program of the management server.

FIG. 15 is a flow chart for explaining a process of a reconfiguration detecting program of the management server.

FIG. 16 is a flow chart for explaining a process of a reconfiguration program of the management server.

### DETAILED DESCRIPTION OF PREFERRED EMBODIMENT

Hereinafter, an explanation will be given on a preferred embodiment according to the present invention with reference to the attached drawings.

### Configuration and Outline of System

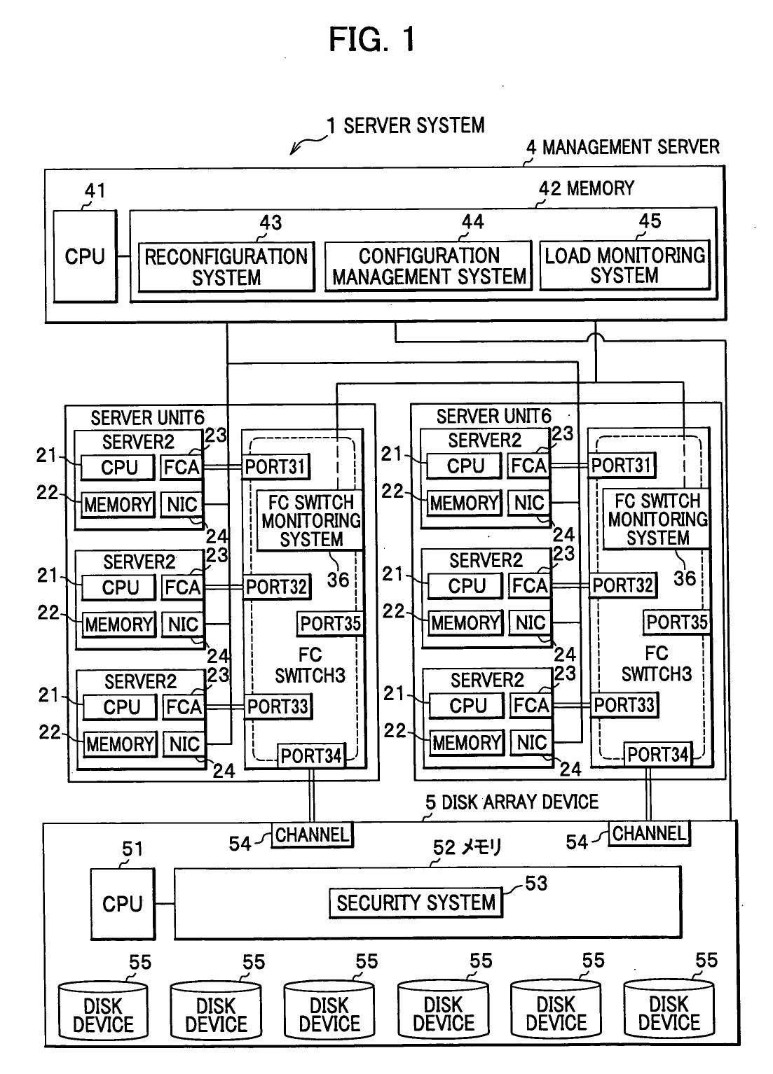

With reference to FIG. 1, a description will be given on an outline of a server system according to an embodiment of the present invention.

The server system 1 comprises a management server 4, a disk array device 5 and server units 6. In each server unit 6 including servers 2, application programs make an input/output request on data stored in the disk array device 5 if necessary, while performing various predetermined processes.

The management server 4 monitors loads of the above data input/output (I/O load), and migrates a disk image (contents of a boot disk drive and a data disk drive) used by one server 2 in the server unit 6 to another server 2 in a different server unit 6, depending on the monitoring situation. In this case, if a disk drive used by the migration source server 2 is incorporated in the same server 2, the disk image is deployed from the migration source server 2 to a migration destination server 2. A specific description on this deployment scheme is disclosed in U.S. Patent App. Pub. No. 2005-010918.

The management server 4 comprises a CPU (Central Processing Unit) 41 and a memory 42. The memory 42 stores programs including a reconfiguration system 43, a configuration management system 44 and a load monitoring system 45. The CPU 41 loads one of the programs stored on the memory 42 onto a main storage device (not shown in the drawing) and executes it so that the management server 4 is activated. The management server 4 is connected through a network to each server 2, each FC switch monitoring system 36 and the disk array device 5, and inquires and updates each table (described later). The memory 42 is implemented with a nonvolatile storage device such as a hard disk device.

Each server unit 6 comprises at least one server 2 and a FC switch 3. The server 2 executes an access to the disk array device 5 through the FC switch 3. The server 2 comprises a CPU (processing unit) 21, a memory 22, a FCA (Fibre Channel Adapter) 23 and a NIC (Network Interface Card) 24. The details of each component of the server 2 will be described later. The FC switch 3 comprises ports 31 to 35 and a FC switch monitoring system 36. The ports 31 to 35 are connected to the servers 2 in the same server unit 6 and the disk array device 5, and a port switching operation is executed in the FC switch between the ports 31 to 35 and the servers 2 or the disk array device 5. In FIG. 1, for example, each of the ports 31 to 33 is connected to its corresponding server 2, the port 34 is connected to the disk array device 5 and the port 35 is free. The FC switch monitoring system 36 monitors data flow rate at each of the ports 31 to 35, and provides an API (Application Program Interface) function so that the load monitoring system 45 in the management server 4 can inquire the monitored content.

The disk array device 5 comprises a CPU (processing unit) 51, a memory 52, channels 54 and disk devices 55. The memory 52 stores programs including a security management system 53. The CPU 51 loads a program stored on the memory 52 onto the main storage device (not shown in the drawing) and executes it so that the disk array device 5 operates. The security management system 53 is a program for managing a logical number and a physical number of each volume and also for managing mapping of the volumes and the servers within the disk array device 5. Each of the channels 54 serves as an interface to face external data flows, and is connected to the port 34 of the FC switch. The disk device 55 provides a storage area in the disk array device 5. The memory 52 and the disk device 55 are implemented with a nonvolatile storage device such as a hard disk device.

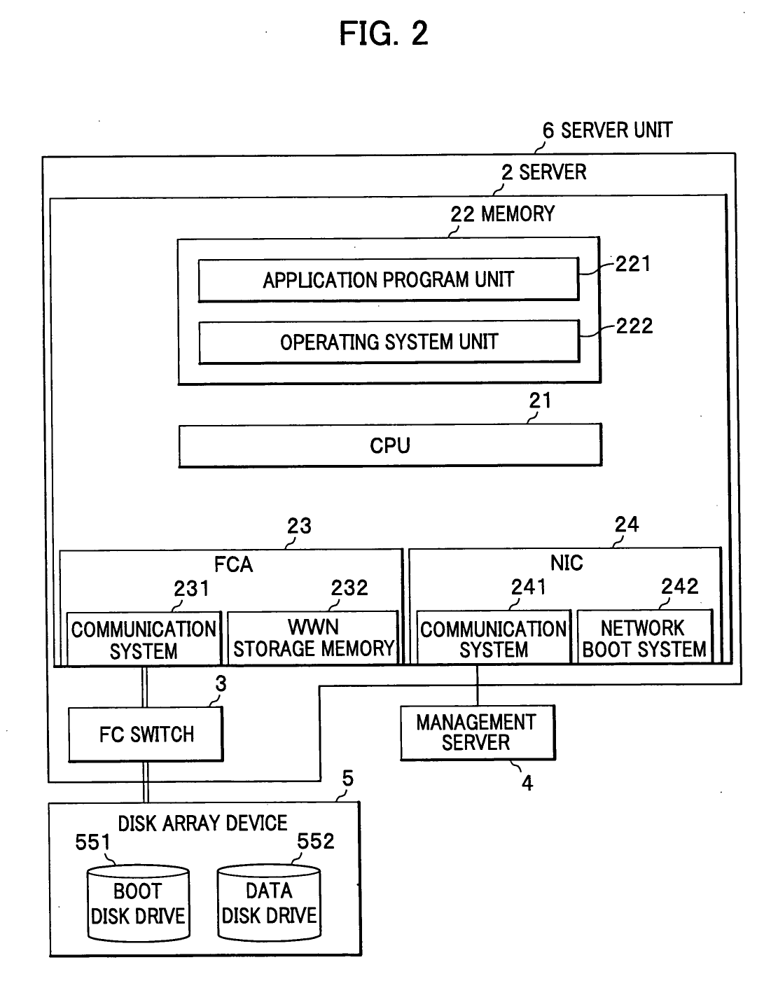

FIG. 2 shows a configuration of the server unit and its peripheral configuration.

The server 2 has a configuration in which the CPU 21 is connected to the memory 22, the FCA 23 and the NIC 24. The memory 22 stores programs including an application program unit 221 and an operation system unit 222. The memory 22 is implemented with a RAM (Random Access Memory) or the like. The CPU 21 executes one of the programs stored on the memory 22 so that the server 2 operates. The application program unit 221 includes programs and objects performing on the operating system.

FCA 23 comprises a communication system 231 and a WWN (World Wide Name) storage memory 232. The communication system 231 is connected to the FC switch 3 so as to provide fibre channel communication. The WWN storage memory 232 is a nonvolatile memory for storing WWNs. This WWN is a unique device identifier that is required for fibre channel communication, and is appended to each node connected to FC switch (including the servers 2 and the disk array device 5). A communication destination over the fibre channel can be determined by use of the WWNs. The communication system 231 performs fibre channel communication by inquiring the WWNs stored on the WWN storage memory 232.

The NIC 24 comprises a communication system 241 and a network boot system 242. The communication system 241 is connected through a network to the management server 4 so as to perform network communication. The network boot system 242 can operate when activating the server 2, and has a function of acquiring a necessary program to activate the serve 2 via the network.

The disk array device 5 comprises a boot disk drive 551 and a data disk drive 552. The boot disk drive 551 is a disk device for storing application programs or operating systems that are performed on the server 2. The server 2 executes an access to the boot disk drive 551 through the FC switch 3 and reads programs and stores them on the memory 22. The stored programs comprise the application program unit 221 and the operating system unit 222. The data disk drive 552 is a disk device for storing data to which the application program unit 221 executes an access when necessary.

The boot disk drive 551 storing the application programs and the operating systems may be incorporated in the server 2. The disk array device 5 shown in FIG. 2 merely indicates a logical configuration of the device 5 seen from the server 2, not indicating a hardware configuration thereof.

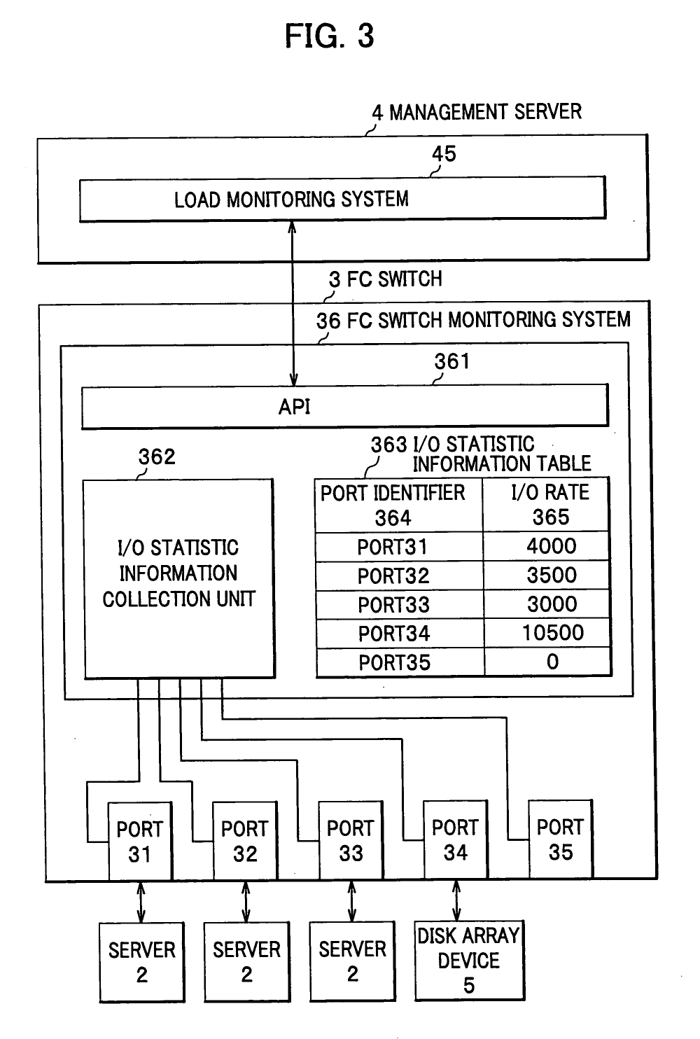

With reference to FIG. 3, a description will be given on a configuration of the FC monitoring system for the FC switches and its peripheral configuration. The FC switch monitoring system 36 comprises an API 361, an I/O statistic information collection unit 362 and an I/O statistic information table 363. The API 361 is an interface for providing I/O statistic information for the load monitoring system 45 of the management server 4 via the network. The I/O statistic information collection unit 362 is connected to the ports 31 to 35, provides a measurement on data flow rate at each port and sets a result of the measurement for each pot on the. I/O statistic information table 363. The I/O statistic information table 363 comprises port identifier 364 and I/O rate 365 that is summed since a previous summarization (hereinafter referred to as “I/Orate”). The port identifier 364 serves as identifying each port of the same FC switch 3, and identifying the ports 31 to 35 by its value, in this case. The I/O rate 365 indicates data flow rate at each port in byte (unit: MB) . Note that the I/O rate 365 is cleared every time the load monitoring system 45 inquires the API 361 to sum the I/O rate for each port, therefore, a value accumulated since a previous summarization is reflected on the I/O rate 365.

The ports 31, 32 and 33 are respectively connected to its server. The port 34 is connected to the disk array device 5. Each server 2 executes an access to the disk array device 5 via the ports 31, 32 and 33, and then via the port 34. This indicates, as seen in the I/O statistic information table 363 of FIG. 3, a value summed by the I/O rates of the ports 31 to 33 becomes a value for I/O rate of the port 34.

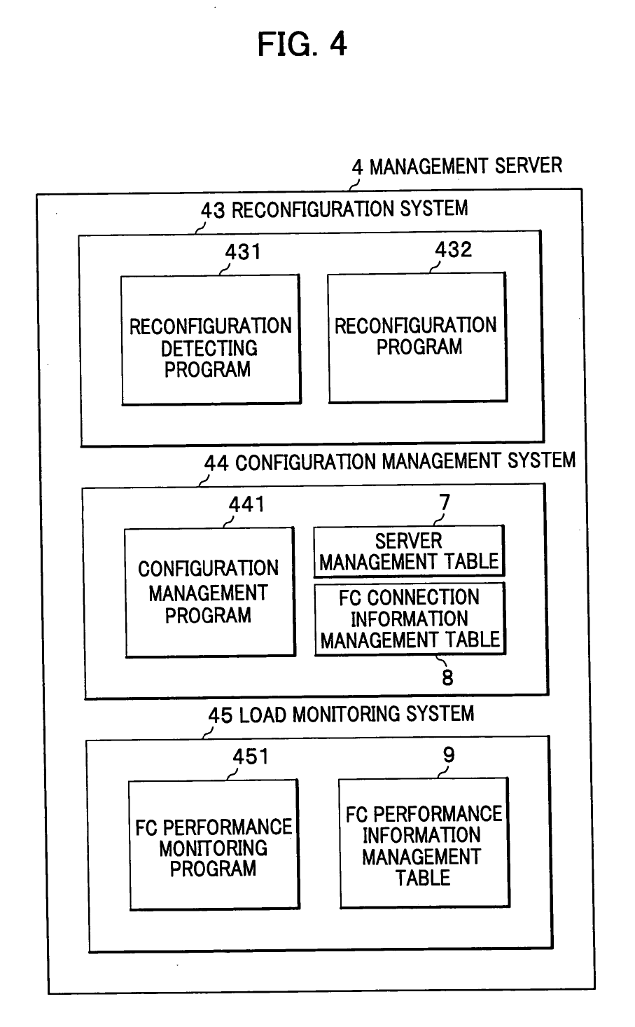

Referring to FIG. 4, a description will be provided on a program configuration of the management server. The management server 4 comprises the reconfiguration system 43, the configuration management system 44 and the load monitoring system 45. The reconfiguration system 43 monitors whether any reconfiguration is necessary or not, and performs a reconfiguration operation if necessary. The reconfiguration is accomplished by deploying the disk images or reconfiguring the servers 2 and the disk array device 5. The reconfiguration system 43 comprises a reconfiguration detecting program 431 and a reconfiguration program 432. The reconfiguration detecting program 431 checks an I/O rate of each port at predetermined time intervals, and calls the reconfiguration program 432 if any reconfiguration is necessary. The reconfiguration program 432 performs a reconfiguration operation in accordance with directions from the reconfiguration detecting program 431. At this time, the configuration management program 441 is called, as described in details later.

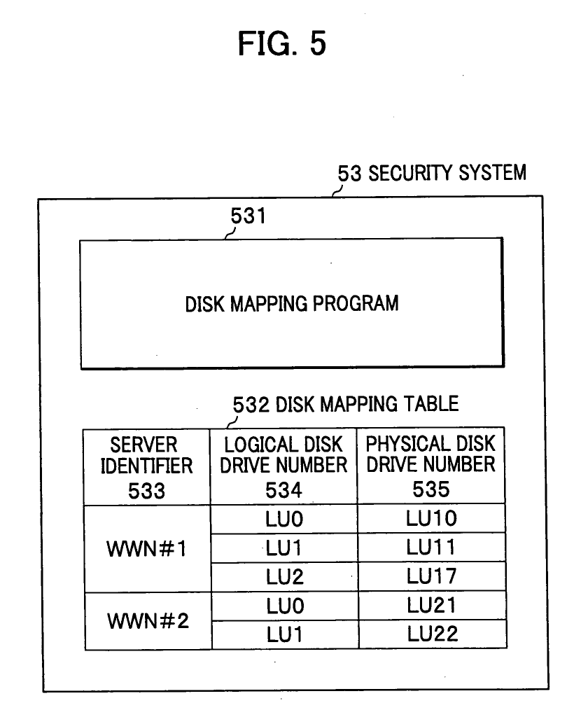

The configuration management system 44 provides a management on a configuration of the servers 2 and the disk array device 5. The configuration management system 44 comprises a configuration management program 441, a server management table 7 and a FC connection information management table 8. The configuration management program 441 updates the server management table 7 and a disk mapping table 532 (see FIG. 5) in accordance with directions from the reconfiguration program 432. The server management table 7 is a table for providing management for each server 2 of one server unit 6 in terms of statuses of disk drives to which the server 2 accesses or a status of the server 2 itself. The FC connection information management table 8 is a table for managing information on a device that is connected to each port of one FC switch. The disk mapping table 532 is a table for providing management for each server 2 in terms of associations between its logical disk drive number and its physical disk drive number. A detailed explanation on each table in FIG. 4 will be given later.

The load monitoring system 45 monitors data transfer rate at each pot of the FC switch 3 via the FC switch monitoring system 36 of the FC switch. The load monitoring system 45 comprises a FC performance monitoring program 451 and a FC performance information management table 9. The FC performance monitoring program 451 uses the API 361 provided by the FC switch monitoring system 36 so as to acquire an I/O rate of each port at predetermined time intervals and to update the FC performance information management table 9 based on the value of the acquired I/O rate. The FC performance information management table 9 is a table for proving management for each port of the FC switch in terms of performance information (data transfer rate), as described in details later.

FIG. 5 shows the program configuration of a security system of the disk array device. The security system 53 associates each disk drive number specified by the server 2 when accessing to the disk drive with its corresponding disk drive number of the disk array device 5, so that the security system 53 prevents any access from a disk device that has no association with a disk drive number specified by the server 2. The security system 53 comprises a disk mapping program 531 and a disk mapping table 532.

The disk mapping program 531 inquires the disk mapping table 532 when there is any access from the server 2, and changes a disk drive number specified at the access from the server 2. Thereby, a data I/O operation can be executed on a volume appended with the disk drive number that has been changed by the server 2. The disk mapping program 531 also updates the disk mapping table 532 so as to associate a disk drive number or to change the association of the disk drive number, in accordance with directions from a management terminal or terminals (not shown in the drawing) connected to the disk array device 5.

The disk mapping table 532 comprises records including server identifier 533, logical disk drive number 534 and physical disk drive number 535. The server identifier 533 is information allowing the disk array device 5 to identify the servers 2. In this case, the server identifier 533 includes WWNs. The logical disk drive number 534 is a unique number in the disk array device 5 that only the servers 2 can see. The logical disk drive number 534 is to be specified when an access is executed from an OS of the server 2 to the disk array device 5. The physical disk drive number 535 is a unique disk drive number predetermined in the disk array device 5.

Each volume can be uniquely identified with this number, with no other volumes having the same number. In the case where the disk array device 5 is configured in RAID (Redundant Array of Independent Disks), a logical device number (number for logical volume) and a physical device number (number for a hard disk drive device) are used in this RAID configuration, and the logical device number is corresponding to the physical disk drive number 535. Note that LU (Logical Unit) shown in FIG. 5 is a logical volume unit that is a unit for volumes that the OS of the servers 2 accesses to, or volumes that the disk array device 5 manages.

In the disk mapping table 532 in FIG. 5, for example, “LU0” of the logical disk drive number 534 and “LU10” of the physical disk drive number 535 are associated with “WWN#1” as the server identifier 533. “LU0” of the logical disk drive number 534 and “LU21” of the physical disk drive number 535 are associated with “WWN#2” as the server identifier 533. The disk-mapping program 531 inquires the association between these identifiers for the servers 2 and the disk drive numbers every time any disk drive number is changed. Specifically, a data I/O is carried out for “LU10” when having an access with specifying “LU0” from WWN#1 server, and a data I/O is carried out for “LU21” when having an access with specifying “LU0” from WWN#2 server. Hence, the servers 2 can access to the LUs of the physical disk drive number 535 that have been associated on the disk mapping table 532, but cannot access to any other LUs. This is why this system is called as a “security system”.

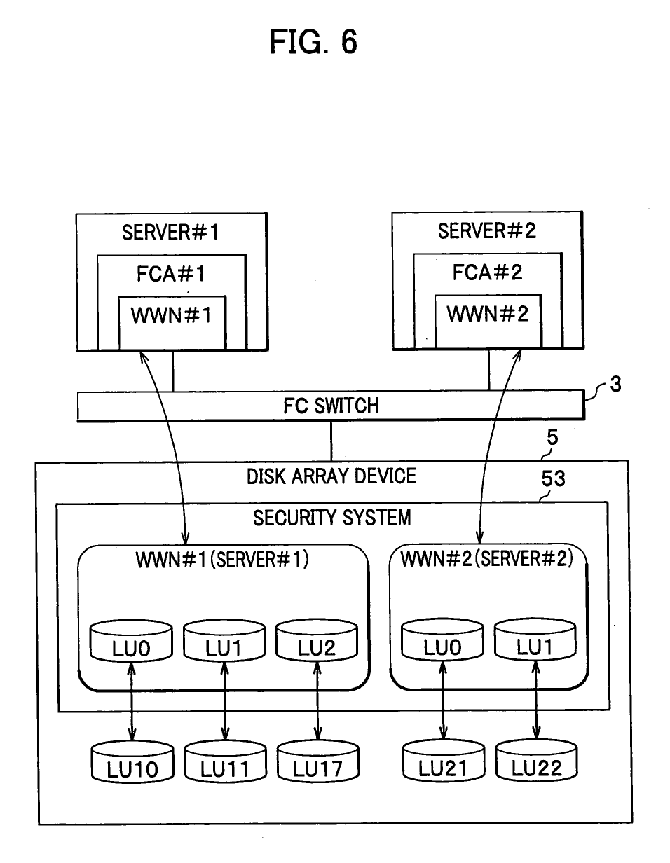

FIG. 6 shows an outline of how an access is executed from the servers to the disk array device. In other words, this represents how to manage the LUs based on the disk mapping table 532 in FIG. 5. The LUs represented inside the security system 53 are corresponding to the logical disk drive number 534 in FIG. 5. The LUs outside the security system 53 are corresponding to the physical disk drive number 535 in FIG. 5. For example, the server#1 of the WWN #1 accesses to the disk array device 5, with specifying LU0, LU1 or LU2. However, the actual access for data I/O is carried out to LU10, LU11 or LU17. If the server #2 of the WWN #2 accesses to the disk array device 5, with specifying LU0 or LU1, the actual access for data I/O is carried out to LU21 or LU22.

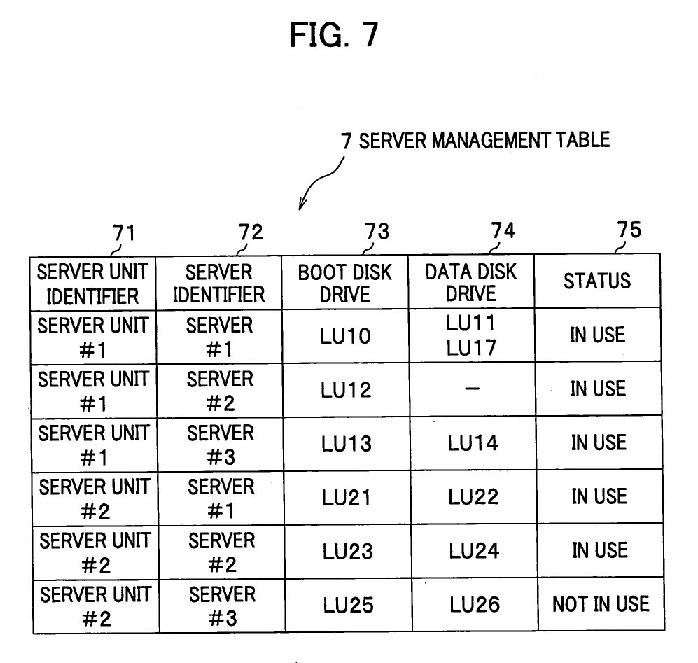

FIG. 7 shows an outline showing the server management table for the management server. The server management table 7 comprises records including server unit identifier 71, server identifier 72, boot disk drive 73, data disk drive 74 and status 75. The server unit identifier 71 is a number uniquely appended to each server unit. The server identifier 72 is a number uniquely appended to each server. The boot disk drive 73 donates a physical disk drive number of a boot disk drive accessed by a server that is identified by the server unit identifier 71 and the server identifier 72 (hereinafter referred to as “that server”). The data disk drive 74 is a physical disk drive number of a data disk drive accessed by that server. Note that the boot disk drive and the data disk drive may be incorporated not only in the disk array device 5 but also in any of the servers 2. If incorporated in the server 2, a flag is set on the drive 73 or 74 to indicate the disk device incorporated in the server, instead of using a physical disk drive number (hereinafter referred to as “incorporation flag ”) . The above explanation has been give on how to set a physical disk drive number to the boot disk drive 73 and the data disk drive 74, assumed that there is only one disk array device 5 which is connected to the FC switches 3. However, if plural disk array devices 5 are connected to the FC switches 3, this setting to the boot disk drive 73 and the data disk drive 74 may include further information to identify each disk array device 5. The status 75 is a flag for indicating an operation status of that server. If the status 75 indicates “in use”, it shows that that sever is powered and on operation. The status 75 indicating “not in use” shows that said server is off-powered and available.

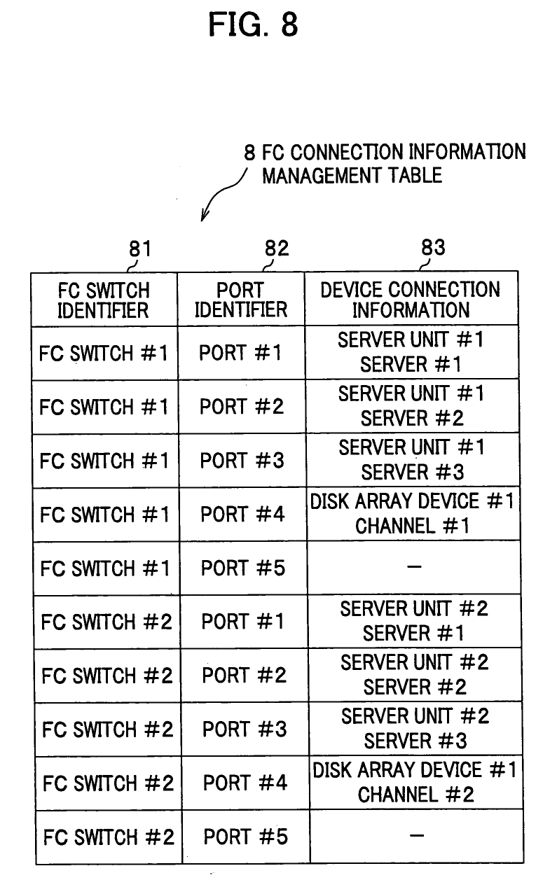

FIG. 8 shows a configuration of the FC connection information management table for the management server. The FC connection information management table 8 comprises records including FC switch identifier 81, port identifier 82 and device connection information 83. The FC switch identifier 81 is a number uniquely appended to each FC switch. The port identifier 82 is a number uniquely appended to each port of the FC switch. The device connection information 83 is information on devices connected to each corresponding port identified by the FC switch identifier 81 and the port identifier 82. As shown in FIG. 8, if a connecting device is a server, for example, a server unit identifier and a server identifier are to be set on the device connection information 83. If the connecting device is a disk array device, a disk array device identifier (a unique number for a disk array device) and a channel identifier (a unique number for a channel) are set on the device connection information 83. The disk array device 5 has plural channels, and each of the channels can handle an access from any of the servers 2 independently. Note that an indicator “−” is set for a port connected to no device on the device connection information 83.

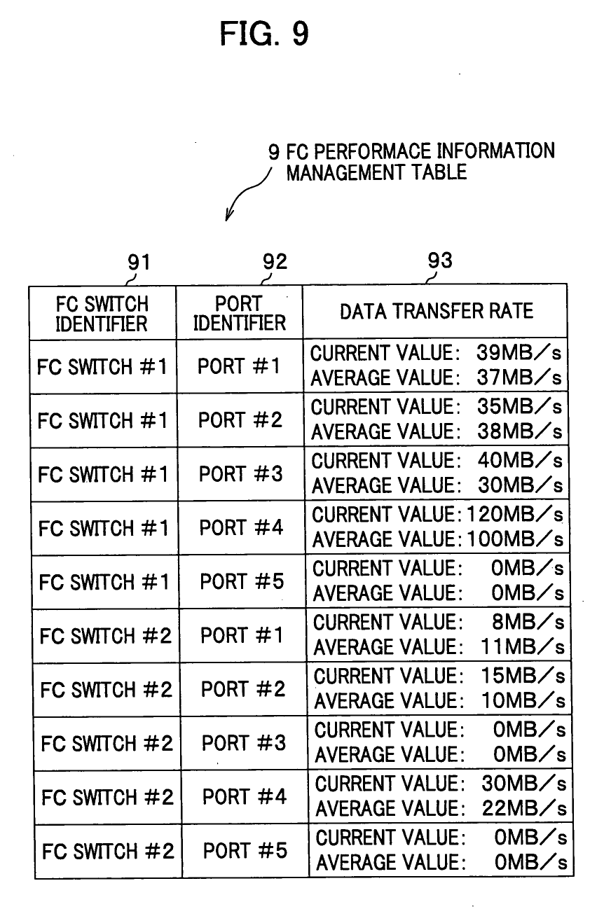

With reference to FIG. 9, a description will be given on a configuration of the FC performance information management table of the management server. The FC performance information management table 9 comprises records including FC switch identifier 91, port identifier 92 and data transfer rate 93. The FC switch identifier 91 is a number uniquely appended to each FC switch. The port identifier 92 is a number uniquely appended to each port of the FC switch. The data transfer rate 93 is data transfer rate from a port identified by the FC switch identifier 91 and the port identifier 92. As seen in FIG. 9, the data transfer rate 93 includes a current value and an average value. The current value is the latest data transfer rate, and the average value is an average value of data transfer rate at a given time to the current time. The calculation method will be described later. Note that the FC performance information management table 9 is updated periodically by the FC performance monitoring program 451 of the management server 4.

### Outline of Reconfiguration

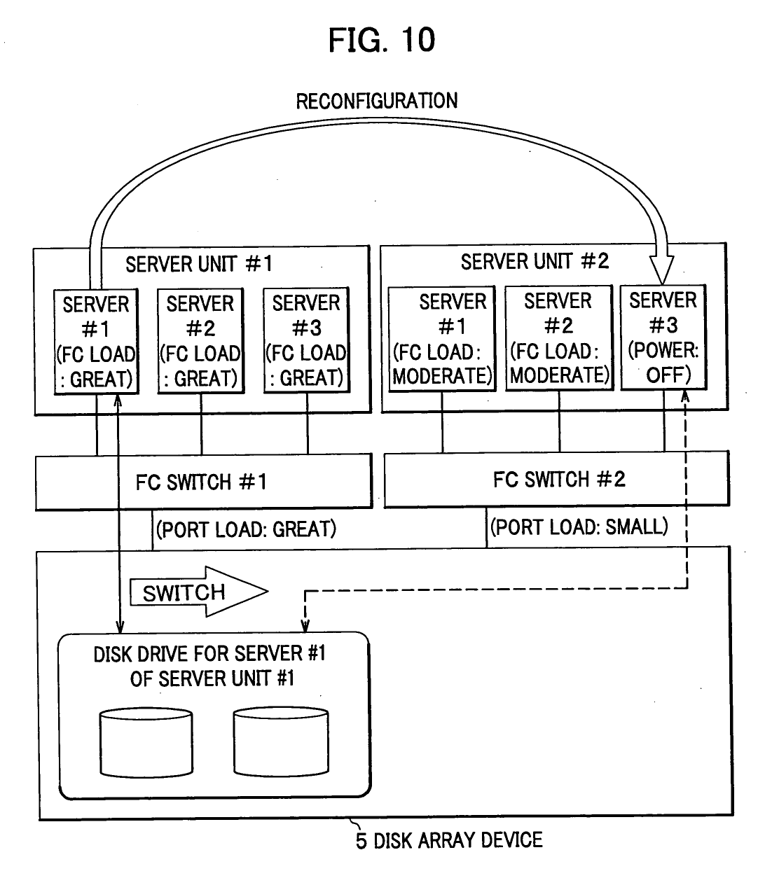

FIGS. 10 to 13 show an outline of processes to change disk images between the servers (i.e. processes of reconfiguration). In order for reconfiguration of disk images, it is required to change a connection configuration of the servers and a disk array device and deliver the disk image (i.e. deploying). Now, an explanation on how to migrate the disk image from one server to another server, and further explanation will be described later.

As shown in FIG. 10, a server unit #1 is connected to a FC switch #1, and a server unit #2 is connected to a FC switch #2. Then, the FC switch #1 and FC switch #2 are connected to the disk array device 5, respectively. The server unit #1 comprises servers #1, #2 and #3, and the server unit #2 comprises servers #1, #2 and #3, as well.

Each of the servers #1, #2 and #3 included in server unit #1 performs an access operation thought the switch #1. Each of the servers #1, #2 and #3 included in server unit #2 performs an access operation thought the switch #2, as well.

In this system configuration, a load on the port of the FC switch #1 connected to disk array device 5 is great. This is considered to be caused by such a factor that each FC load on the servers #1, #2 and #3 of the server unit #1 is great. On the other hand, a load on the port of the FC switch #2 connected to disk array device 5 is small. This is considered to be caused by such a factor that each FC load on the servers #1 and #2 of the server unit #2 is moderate and the server #3 is off-powered (not in use).

In order to equalize this unbalance of I/O load, distribution of I/O load may be employed. To accomplish this I/O load distribution, a disk image of the server #1 of the serve unit #1 is migrated (reconfigured) to the server #3 of the server unit #2. In this case, the server #1 of the server unit #1 has already made an access to the disk array device 5, so that a connection path between the server #1 of the server unit #1 and the disk array device 5 has been established. Therefore, the connecting path is switched to a path between the disk drive in the disk array device 5 and the server #3 of the server unit #2.

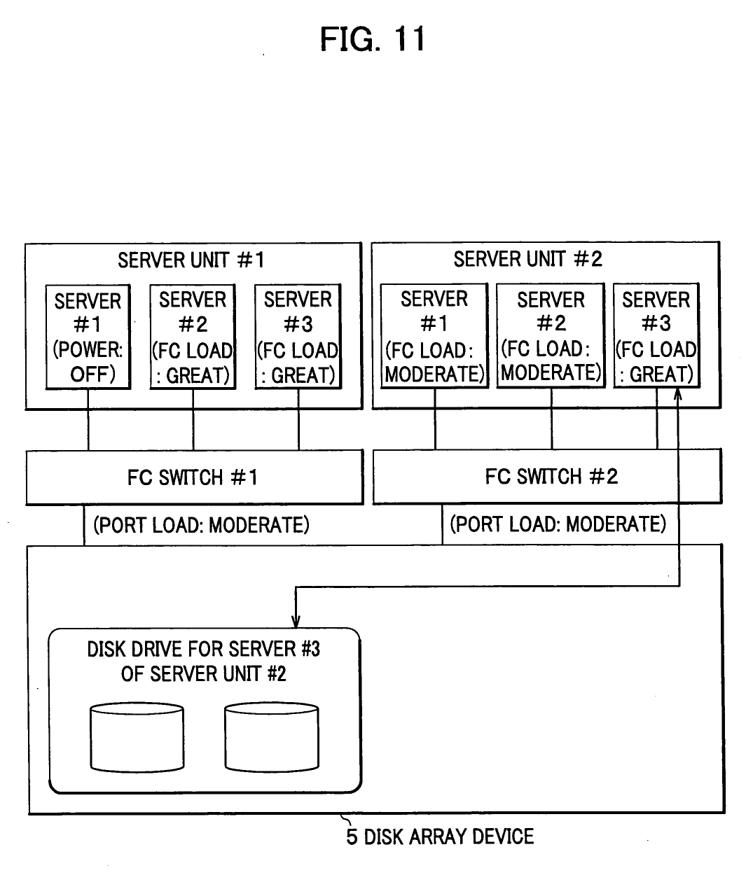

FIG. 11 explains a result of this reconfiguration. As shown in FIG. 11, after the reconfiguration, the server #1 of the server unit #1 is off-powered, and the load on the port of the FC switch #1 connected to the disk array device 5 is moderate. The server #3 of the server unit #2 has a great FC load and the load on the port of the FC switch # connected to the disk array device 5 1 is moderate. This indicates the I/O load distribution has been accomplished. Note that a connection path has been established between the server #3 of the server unit #2 and the disk array device 5.

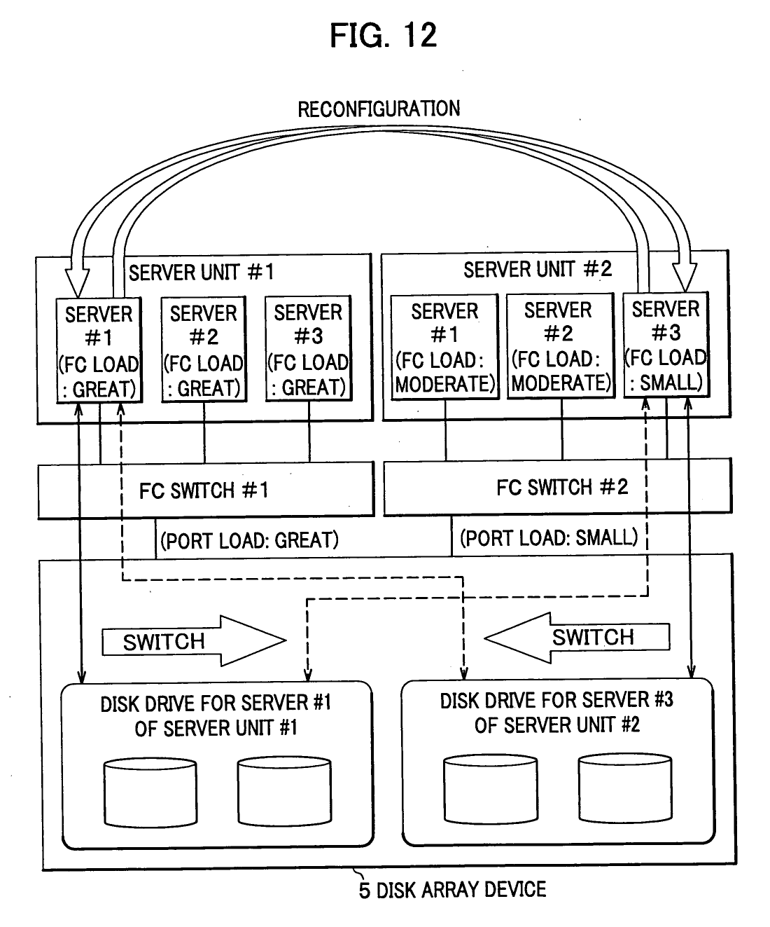

A system configuration shown in FIG. 12 is the same as that in FIG. 10. In this system configuration, a load on the port of the FC switch connected to disk array device 5 is great. This is considered to be caused by such a factor that FC load on each server #1, #2 and #3 of the server unit #1 is great. Meanwhile, a load on each port of the FC switch #2 connected to the disk array device 5 is small. This is considered to be caused by such a factor that FC load on each server #1, #2 and #3 of the server unit #2 is moderate, and FC load on the server is small.

In order to equalize this unbalance of I/O load, distribution of I/O load is employed. To accomplish this I/O load distribution, a disk image of the server #1 of the server unit #1 is exchanged (reconfigured) with a disk image of the server #3 of the server unit #2. In this case, the server #1 of the server unit #1 has already made an access to the disk array device 5, so that a connection path between the server #1 of the server unit #1 and the disk array device 5 has been established. Therefore, the connecting path is switched to a path between the disk drive in the disk array device 5 and the server #3 of the server unit #2. Further, the server #3 of the server unit #2 has already made an access to another disk drive of the disk array device 5, so that the connection path between the server #3 of the server unit #2 and the disk array device 5 has been established. Therefore, the connecting path is switched to the path between the above disk drive and the server #1 of the server unit #1.

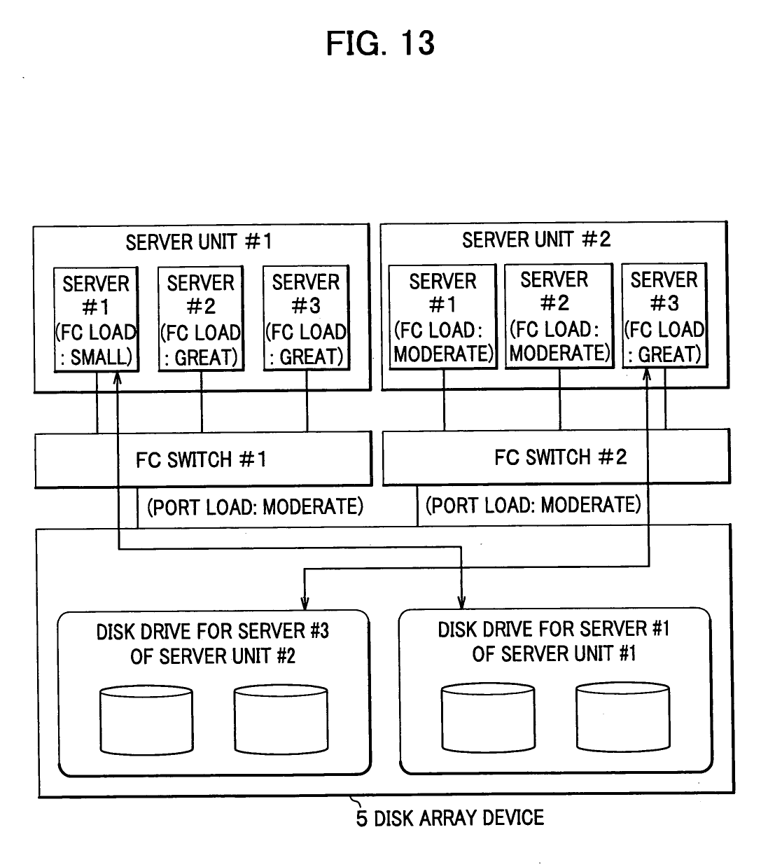

FIG. 13 shows a result of this configuration.

As shown in FIG. 13, after the reconfiguration, the server #1 of the server unit #1 has a small FC load, and the load on the port of the FC switch #1 connected to the disk array device 5 is moderate. The server #3 of the server unit #2 has a great FC load, and the load on the port of the FC switch #2 connected to the disk array device 5 is moderate. This indicates the I/O load distribution has been accomplished. In this case, the server #3 of the server unit #2 has already had a connection path to a disk drive that has been used for the server #1 of the server unit #1 among the disk drives of the disk array device 5. Further, the server #1 of the server unit #1 has already had a connection path to a disk drive that has been used for the server #3 of the server unit #2 among the disk drives of the disk array device 5.

### Process for System

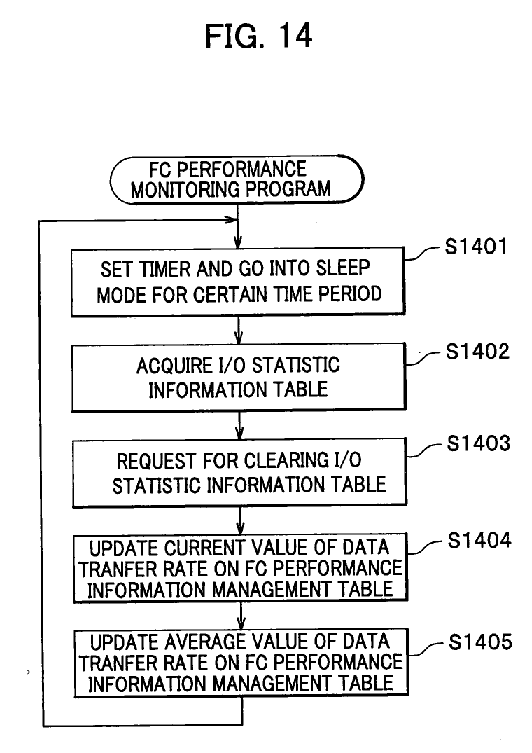

With reference to FIGS. 14 to 16, an explanation will be given on a series of processes for the server system according to the embodiment of the present invention (see FIGS. 1 to 9 if necessary).

Hereinafter, an explanation on processes of the management server 4 represents as an explanation on overall processes of the system server according to the present invention.

The order of the explanation goes as follows:

First, with reference to FIG. 14, an explanation 4 will be given on a process of the load monitoring system 45 of the management server 4, for monitoring I/O status, and updating the FC performance information management table 9 based on the status.

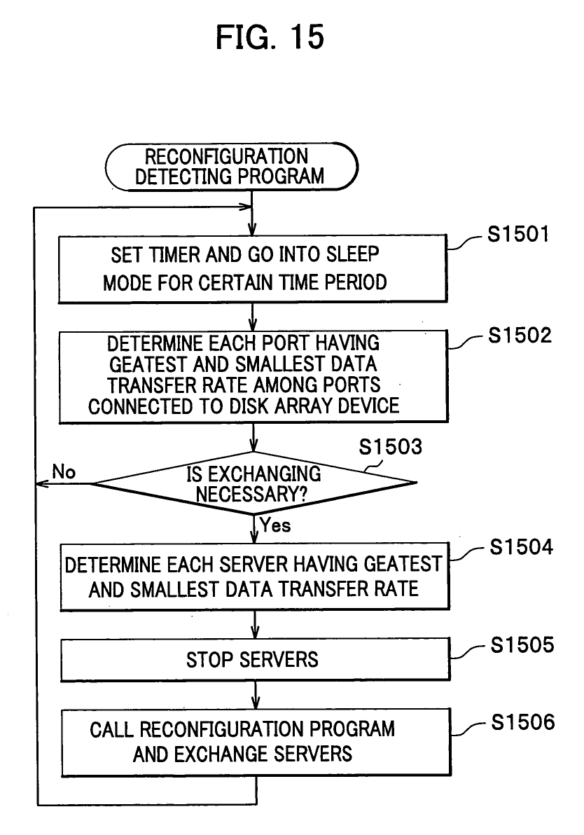

Next, in FIG. 15, the reconfiguration detecting program 431 of the reconfiguration system 43 of the management server 4 inquires the FC performance information management tale 9 updated by the FC performance monitoring program 451 and performs a server exchanging process if necessary.

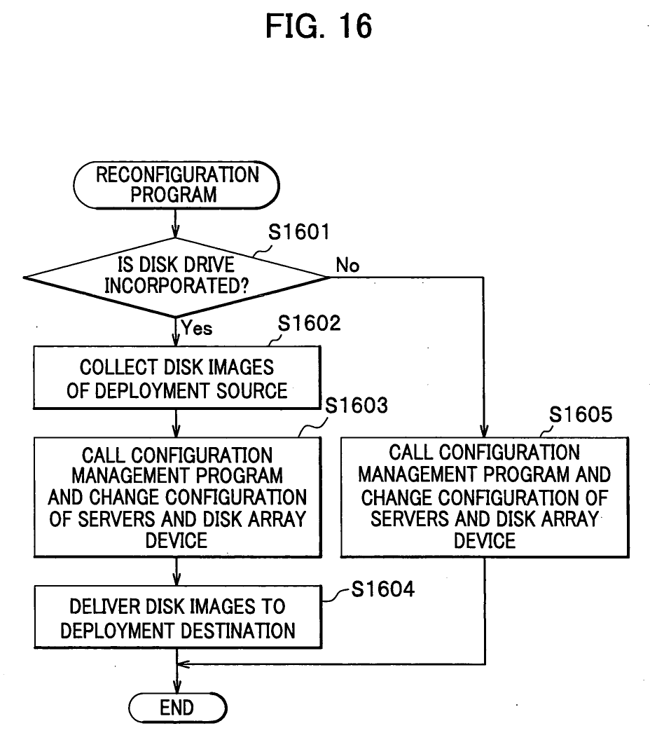

Then, referring to FIG. 16, an explanation will be given on a reconfiguration process carried out by the reconfiguration program 432 of the reconfiguration system 43 of the management server 4 in response to a call from the reconfiguration detecting program 431.

FIG. 14 is a flow chart for explaining a process carried out by the FC performance monitoring program. In the management server 4, the FC performance monitoring program 415 periodically goes into sleep mode for a certain time period (e.g. 1 to 10 minute intervals) by setting the timer thereof (S1401). In other words, the FC performance monitoring program 415 is set in wake-up mode for a certain time period so as to perform the processes of the steps S1402 to S1405 periodically. First, the FC performance monitoring program 415 is activated to acquire (collect) the content of the I/O statistic information table 363, by using API 361 (see FIG. 3) provided from the FC switch monitoring system 36 of each FC switch 3 (S1402). At this time, the API 361 sends the content of the I/O statistic information table 363, in response to the request from the FC performance monitoring program 415. In this case, the FC performance monitoring program 415 may acquire this API 361 from some (more than one) of or all of the FC switch monitoring systems 36 of the server system 1 connected to the management server 4.

Next, the FC performance monitoring program 415, by using the API 361, makes a request to clear the content of the I/O statistic information table 363 (S1403). In this case, in response to the request from the FC performance monitoring program 415, the API 361 clears the content of the I/O statistic information table 363. This clearing the content makes sense that the I/O rate 365 on the I/O statistic information table 363 is based on “the I/O rate summed since a previous summarization”.

The FC performance monitoring program 415 updates the current value of the data transfer rate 93 on the FC performance information management table 9 (see FIG. 9), based on the content of the I/O statistic information table 363 acquired at the step S1402 (S1404). Specifically, each current value of the data transfer rate 93 is obtained in such a manner that the I/O rate 365 for each FC switch identifier 91 and each port identifier 92 on the FC performance information management table 9 are divided by the monitoring time period (certain time period at S1401).

Then, the FC performance monitoring program 415, by using the current value on the data transfer rate 93 updated at the step S1404 and other data retained separately, obtains the average value of the data transfer rate and updates the average value for the data transfer rate 93 on the FC performance information management table 9 (S1405). The other data retained separately includes the summed current value of the data transfer rate 93 accumulated since the previous summarization and the number of times of updating the data transfer rate 93. If this summed current value is divided by the number of updating times, it yields an average value of the data transfer rate 93 before updating. Therefore, to find an average value to be updated, first, the current value of the data transfer rate 93 is added to the above summed current value so as to yield a latest summed value. Next, the number of updating times is incremented by adding 1 so as to obtain the latest number of updating times. The latest summed value as obtained above is divided by this latest number of update times, whereby an average value to be updated is obtained. In this case, the latest summed value and the latest number of updating times are retained until the next time of updating (S1405).

The FC performance monitoring program 451 goes into sleep mode after the completion of updating the FC performance information management table 9 for a certain time period (e.g. 1 to 10 minute interval) by setting the timer thereof (S1401) The FC performance monitoring program 451 may be set to output for a system administrator an updated content of the FC performance information management table 9 every time it is updated. For example, the content may be displayed on an appropriate displaying means of the management server 4, or may be transmitted via a network to other servers or terminal devices. According to the present embodiment, a decision making on whether a reconfiguration between the servers is carried out or not may be dependent on the system administrator.

FIG. 15 is a flow chart for explaining a series of processes of the reconfiguration detecting program. In the management server 4, the reconfiguration detecting program 431 periodically goes into sleep mode for a certain time period (e.g. 1 to 10 minute interval) by setting the timer thereof (S501) . In other words, the reconfiguration detecting program 431 is set in wake-up mode for a certain time period so as to perform the processes of the steps S1502 to S 1506 periodically. First, the reconfiguration detecting program 431 determines ports having the greatest data transfer rate and ports having the smallest data transfer rate among ports connected to the same disk array device 5 (S1502).

Specifically, the FC connection information management table 8 is searched for the device connection information 83 (see FIG. 8) by using “disk array device #1” as a search key, so as to extract the FC switch identifier 81 and the port identifier 82 of appropriate records. Then, inquiring the FC performance information management table 9 as shown in FIG. 9, the reconfiguration detecting program 431 finds a maximum value and a minimum value among the data transfer rate 93 for the FC switch identifier 91 (or 81 in FIG. 8) and the port identifier 92 (or 82 in FIG. 8) that have been extracted, whereby to determine the ports having the greatest data transfer rate and the ports having the smallest data transfer rate. In this case, either of an average value or a current value may be used as the data transfer rate 93. In general, an average value can be used for the load distribution, but a current value at a peek time of I/O load may also be used if it is expected to accomplish the load distribution at a peek time of I/O load, for example.

Following the above step, the reconfiguration detecting program 431 determines whether exchanging of disk images between the servers is necessary or not (S1503). Specifically, this step is accomplished by calculating a difference or a ratio between the maximum value and the minimum value found at the step S1502, and then comparing the value to a predetermined threshold value. For example, it may be assumed that when the maximum value becomes more than twice as much as the minimum value, it may be determined that exchanging the disk images between the servers is necessary. In other words, this determination checks whether or not the difference between the maximum value and the minimum value (unbalance of the I/O load) is within a range where any correction is required, that is, beyond a predetermined allowable range. This range may be changed according to conditions of the I/O load among the servers 2 of the server system 1. If the exchanging the disk images between the servers is unnecessary (“No” at S1503), the reconfiguration detecting program 431, then, periodically goes into sleep mode for a certain time period by setting the timer thereof (S1501).

If the exchanging the disk images between the servers is necessary (“Yes” at S1503), the reconfiguration detecting program 431 determines a server having the greatest data transfer rate and a server having the smallest data transfer rate (S1504). In this case, the reconfiguration detecting program 431 selects a port having the greatest data transfer rate among ports connected to servers 2 of a FC switch (equivalent to “a first switch” in claims 1, 9 and 10) which the ports having the greatest data transfer rate determined at the step S1502 belong to. Next, the reconfiguration detecting program 431 also selects a port having the smallest data transfer rate among ports connected to servers 2 within a FC switch (equivalent to “a second switch” in claims 1, 9 and 10) which the ports having the smallest data transfer rate determined at the step S1502 belong to. Then, a server 2 corresponding to each selected port is determined.

Specifically, first, the reconfiguration detecting program 431 inquires the FC connection information management table 8. Next, the reconfiguration detecting program 431 extracts ports having the same device connection information 83 on the server 2 of the server unit 6 from the port identifier 82 of the FC switch identifier 81 to which the ports having the greatest data transfer rate identified at the step S1502 belong. Thereafter, the reconfiguration detecting program 431 inquires the FC performance information table 9, and selects a port having the greatest data transfer rate out of the extracted ports, and then determines the server 2 (i.e. a server having the greatest data transfer rate) corresponding to this selected port having the greatest data transfer rate. A server having the smallest data transfer rate can also be determined by using this process.

Next, the reconfiguration program 431 stops the servers 2 determined at the step S1504 (S1505). Specifically, the program 431 makes a request for shut down on the determined servers 2. Then, the program 431 calls the reconfiguration program 432 so as to execute a server exchanging operation (S1506). Specifically, the program 431 calls the reconfiguration program 432 by using an exchanging source server and an exchanging destination server as parameters. After the completion of exchanging the servers, the reconfiguration detecting program 431 periodically goes into sleep mode for a certain time period by setting the timer thereof (S15O1).

FIG. 16 is a flow chart for explaining a series of processes performed by a reconfiguration program. The reconfiguration program 432 is activated by a call of the reconfiguration detecting program 431.

This call sends a server unit identifier and a server identifier for identifying the source server and the destination server to be exchanged, as input parameters. First, the reconfiguration program 432 determines whether or not a disk drive corresponding to the source server 2 is incorporated in the server 2. (S1601) Specifically, the reconfiguration program 432 inquires the server management table 7 as shown in FIG. 7, and checks whether an incorporation flag is set on the boot disk drive 73 or the data disk drive 74, which are respectively corresponding to the server unit identifier 71 and the serve identifier 72 of the exchanging source as the input parameters.

If there is any disk drive incorporated in the server 2 (“Yes” at S1601), the reconfiguration program 432 collects a disk image of the deployment source of the incorporated disk drive (S1602) . Next, the configuration management program 441 is called to reconfigure the server 2 and the disk array device 5 (S1603). At this time, a migration source server and a migration destination server are used as parameters.

The configuration management program 441, which has been called from the reconfiguration program 432, first updates the server management table 7 shown in FIG. 7. The boot disk drive 73 and the data disk drive 74 respectively corresponding to the server unit identifier 71 and the server identifier 72 of the migration source server, and the status 75 (in use) are copied into each corresponding record for the migration destination server on the server management table 7. The boot disk drive 73 and the data disk drive 74 of the migration source sever are set “disable”, and the status 75 is set “not in use”. If the status 75 on both the migration source server and the migration destination server becomes “in use”, an exchanging operation is executed on the boot disk drive 73, the data disk drive 74 and the status 75 between the records of the migration source server and the migration destination server.

Next, the configuration management program 441 updates the disk mapping table 532 of the disk array device 5 in FIG. 5. An access to the disk mapping table 532 is executed via a network and the disk mapping program 531 of the security system 53. Herein, assumed that the data disk drive is incorporated in the disk array device 5, the updating is carried out on the disk mapping table 532. Specifically, a migration or exchanging operation is executed on the physical disk drive number 535 on the disk mapping table 532, corresponding to the data disk drive 74 that has already been migrated or exchanged on the server management table 7. The server unit identifier 71 and the server identifier 72 are associated with the server identifier 533, and the data disk drive 74 is corresponding to an appropriate record for the physical disk drive number 535. Therefore, the physical disk drive number 535 to be migrated or exchanged can be identified by using these associations. As seen in FIGS. 10 and 11, this process changes the correspondence between the logical disk drive number 534 and the physical disk drive number 535 such that the server #3 of the server unit #2 (migration destination server: equivalent to “a second computer” in claims 3, 5) can access to a disk incorporated in the disk array device 5 which has been accessed by the server #1 of the server unit #1 (migration source server: equivalent to “a first computer” in claims 3, 5). If there is no disk drive of the migration source server in the disk array device 5, it is unnecessary to update the disk mapping table 532.

The configuration program 441 sets the program control back to the reconfiguration program 432 (returns to the reconfiguration program 432) after the completion of updating the disk mapping table 532. The reconfiguration program 432 delivers the disk image of the incorporated disk to the deployment destination (S1604). Then, the reconfiguration program 432 completes the processes.

If both the disk drives of the boot disk drive and the data disk drive are not incorporated in the disk array device 5 at the step S1601 (“No” at S1601), the reconfiguration program 432 calls the configuration management program 441 so as to reconfigure the servers 2 and the disk array device 5 (S1605). This process is approximately the same as that at the step S1603 although there is a slight difference resulted from the disk drive which is not incorporated (i.e. network boot disk drive). In other words, the configuration management program 441 performs a migration or exchanging of the physical disk drive number 535 including not only a data disk drive but also a boot disk drive when the program 441 updates the disk mapping table 532. In this case, since the disk drives are not incorporated in the disk array device 5, there is no need to collect and deliver the disk images (S1602 and S1603). Then, the reconfiguration program 432 completes the processes.

As explained above, according to the embodiment of the present invention, first, ports having a great data transfer rate (great load) and ports having a small data transfer rate (small load) are determined among the ports connected to the same disk array device 5, in more than one FC switch 3. Then, comparing the great value and the small value between the data transfer rates, if the difference or ratio of the data transfer rates, a port having the greatest data transfer rate is selected out of the ports connected to the servers 2, in the FC switch 3 with which the determined ports having the great data transfer rate are equipped. Similarly, a port having the smallest data transfer rate is selected out of the ports connected to the servers 2, in the FC switch 3 with which the determined ports having the small data transfer rate are equipped. Then, an exchanging operation is performed between a disk image of a computer connected to the port having the greatest data transfer rate and a disk image of a computer connected to the port having the smallest data transfer rate.

Accordingly, a load distribution between the two servers 2 can be accomplished by exchanging a server 2 causing a high load and a server 2 causing a low load in terms of data I/O to the disk array device 5. Furthermore, this I/O load distribution also realizes a load distribution between the channels 54, so that a proper balance in data I/O of the disk array device 5 can be maintained.

The embodiment according to the present invention can accomplish the load distribution, in whichever of the disk array drive 5 or the server 2 disk drives that the server 2 use are located in. By outputting a data I/O status, a decision making on a disk drive image deployment can be responsible for a system administrator.

As mentioned above, according to the embodiment of the present invention, the server system 1 in FIG. 1 is realized by recording the programs that are executed on each process of the server system 1 on recoding media readable by a computer, and then by reading the recorded programs into a computer system so as to execute the programs. Each of the above mentioned programs may be provided for a computer system via a network such as the Internet.

The embodiments according to the present invention have been explained as aforementioned. However, the embodiments of the present invention are not limited to those explanations, and those skilled in the art ascertain the essential characteristics of the present invention and can make the various modifications and variations to the present invention to adapt it to various usages and conditions without departing from the spirit and scope of the claims.

What is claimed is:

1. A method for distributing data input/output load performed by a management server connected to:
at least one storage device for storing data and for inputting or outputting the stored data in response to an external request;
one or more computers for performing predetermined processes and making a request for input and output of the data stored in the storage device if necessary; and
more than one switches, each of the switches having a port connected to the storage device and the computers, and providing a connection between each port of the switches,
the method comprising:
storing input and output management information on data input/output status of each port, and port connection management information for managing the computers and the storage device connected to each port on an appropriate memory of the management server;
inputting the data input/output status of each port from the corresponding switch thereof at predetermined time intervals, so as to reflect the status on the input and output management information;
inquiring the input and output management information and the port connection management information at predetermined time intervals, so as to determine ports having a great load and ports having a small load among ports connected to a same storage device of the storage devices;
checking whether or not a difference or a ratio of load between the ports having the great load and the ports having the small load is within an allowable range;
if the difference or the rate is beyond the allowable range, inquiring the input and output management information, so as to select a port having the great load out of the ports connected to the computers of a first switch with which the determined ports having the great load are equipped, and inquiring the input and output management information, so as to select a port having the small load out of the ports connected to the computers of a second switch with which the determined ports having the small load are equipped; and
inquiring the port connection management information, exchanging a disk image of a computer connected to the selected port having the great load and a disk image of a computer connected to the selected port having the small load.

2. A data input/output load distribution program for allowing the computers to execute the method for distributing data input/output load according to claim 1.

3. The method for distributing data input/output load according to the claim 1, wherein the disk images of the computers are exchanged by switching a connection path between a first computer and a disk drive of the first computer to a connection path between a second computer and the disk drive if the disk drive of the first computer is located within the same storage device.

4. A data input/output load distribution program for allowing the computers to execute the method for distributing data input/output load according to claim 3.

5. The method for distributing data input/output load according to the claim 1, wherein the disk images of the computers are exchanged by deploying a disk image of a first computer to a second computer if the disk drive of the first computer is located within the first computer.

6. A data input/output load distribution program for allowing the computers to execute the method for distributing data input/output load according to claim 5.

7. A method for distributing data input/output load performed by a management server connected to:
at least one storage device for storing data and for inputting or outputting the stored data in response to an external request;
one or more computers for performing predetermined processes and making a request for input and output of the data stored in the storage device if necessary; and
more than one switches, each of the switches having a port connected to the storage device and the computers, and providing a connection between each port of the switches,
the method comprising:
storing input and output management information on data input/output status of each port, and port connection management information for managing the computers and the storage device connected to each port on an appropriate memory of the management server;
inputting the data input/output status of each port from the corresponding switch thereof at predetermined time intervals, so as to reflect the status on the input and output management information; and
outputting the input and output management information.

8. A data input/output load distribution program for allowing the computers to execute the method for distributing data input/output load according to claim 7.

9. A computer system comprising:
at least one storage device for storing data and for inputting or outputting the stored data in response to an external request;
one or more computers for performing predetermined processes and making a request for input and output of the data stored in the storage device if necessary; and
more than one switches, each of the switches having a port connected to the storage device and the computers, and providing a connection between each port of the switches,
a management server connected to the storage device, the computers and the switches, the management server monitoring data input/output status at each port, and if unbalance of data input/output load between ports connected to a same storage device of the storage devices is beyond an allowable range, exchanging a disk image of a computer connected to a port having a great load among ports connected to computers of a first switch with which ports having the great load are equipped, and a disk image of a computer connected to a port having a small load among ports connected to computers of a second switch with which ports having the small load are equipped.

10. A management server connected to:
at least one storage device for storing data and for inputting or outputting the stored data in response to an external request;
one or more computers for performing predetermined processes and making a request for input and output of the data stored in the storage device if necessary; and
more than one switches, each of the switches having a port connected to the storage device and the computers, and providing a connection between each port of the switches,
the management server comprising the functions of monitoring data input/output status of each port, and if unbalance of data input/output load among ports connected to a same storage device of the storage devices is beyond an allowable range, exchanging a disk image of a computer connected to a port having a great load among ports connected to computers of a first switch with which ports having the great load are equipped, and a disk image of a computer connected to a port having a small load among ports connected to computers of a second switch with which ports having the small load are equipped.
